(19) United States
(12) Patent Application Publication
(10) Pub. No.: US 2026/0336508 A1
(43) Pub. Date: Oct. 29, 2026

(54) MODULE FOR RESOLVING TURN SIGNAL ERRORS

(71) Applicant: David McGiff, Clyde, TX (US)

(72) Inventor: David McGiff, Clyde, TX (US)

(21) Appl. No.: 19/568,945

(22) Filed: Mar. 17, 2026

Related U.S. Application Data
(60) Provisional application No. 63/796,511, filed on Apr. 29, 2025.

(51) Int. Cl. B60Q 1/00; B60Q 1/26; B60Q 1/34; B60Q 1/38; B60Q 11/00

(52) U.S. Cl. CPC B60Q 1/0094; B60Q 1/346; B60Q 1/382; B60Q 1/385; B60Q 11/007; B60Q 1/2696; B60Q 2900/10

(57) ABSTRACT

Apparatus and associated methods relate to a turn signal module (TSM) configured to mimic a functioning LED light by interacting with the vehicle's feedback circuit and sending a signal to a vehicle's lighting control module (LCM). In an illustrative example, a vehicle is equipped with a modified taillight assembly. In some examples, the taillight assembly may not be configured to interact with the LCM. In various examples, the taillight assembly may not ground the voltage or return the voltage on a feedback circuit. In these scenarios, the voltage sent to and from the LCM remains static, resulting in a fault warning being generated by the LCM and potentially hyper flashing of the turn signal. In some implementations, the TCM may be installed in the vehicle. The operation of the TSM may, in some examples, be configured to mimic the behavior of the factory taillight assembly.

### CROSS-REFERENCE TO RELATED APPLICATIONS

This application is a U.S. Non-Provisional Application and claims the benefit of U.S. Application Ser. No. 63/796,511, titled “Module for Resolving Turn Signal Errors,” filed by David McGiff on Apr. 29, 2025.

This application incorporates the entire contents of the foregoing application(s) herein by reference.

### TECHNICAL FIELD

Various embodiments relate generally to vehicles and modules for vehicles.

### BACKGROUND

In some industries, customization may be a desirable feature. Customization may, in some examples, enable each user of a product to modify the product in ways that they want. Building blocks may, for example, allow users to deviate from the original product that they purchased.

For example, building blocks may allow the user of a castle building block set to build a house instead. In this way, the user desirably selects what is going to be built based on their own preferences.

### SUMMARY

Apparatus and associated methods relate to a turn signal module (TSM) configured to mimic a functioning LED light by interacting with the vehicle's feedback circuit and sending a signal to a vehicle's lighting control module (LCM). In an illustrative example, a vehicle is equipped with a modified taillight assembly. In some examples, the taillight assembly may not be configured to interact with the LCM. In various examples, the taillight assembly may not ground the voltage or return the voltage on a feedback circuit. In these scenarios, the voltage sent to and from the LCM remains static, resulting in a fault warning being generated by the LCM and potentially hyper flashing of the turn signal. In some implementations, the TSM may be installed in the vehicle. The operation of the TSM may, in some examples, be configured to mimic the behavior of the factory taillight assembly. In these scenarios, the voltage sent to and from the LCM oscillates between 0 volts and X volts. This may, for example, advantageously prevent the LCM from detecting a fault, preventing the hyper-flashing turn signal issue without disabling other vehicle features.

Apparatus and associated methods relate to a resistor array based electronic circuit (RABEC) that selectively applies a controlled, time-limited resistive load to a turn and brake signal light circuit (TBSLC) to simulate proper lamp behavior while minimizing power dissipation and heat, particularly by distinguishing pulsed turn signals from steady brake signals. In some examples, a feed input comes from the TBSLC. The feed input may, for example, be the power source that the RABEC monitors to determine whether a turn signal pulse is occurring. In some examples, a timing circuit of the RABEC may be configured to detect when the turn signal is being operated. In various examples, the timing circuit may be configured to detect when the brake signal is being operated. In some implementations, the RABEC includes a resistor array network. In various implementations, the RABEC may determine a turn signal by detecting a rising edge of a turn signal pulse. In some examples, the timing circuit detecting a turn signal applies a load to the resistor array only for a controlled time portion of the turn-signal pulse. In some examples, the detection of the turn signals reduces heat generation by energizing the resistor array for significantly less time than the turn signal pulse. In various examples, the timing circuit may determine a brake signal by detecting a steady-state voltage with no pulsing. This detection may, for example, allow the timing circuit to inhibit the resistor array network activation after a brief transient. In some examples, the timing circuit stops current flowing through the load resistors during braking, thus preventing power from being wasted. Various embodiments may advantageously prevent the LCM from detecting a fault, preventing the hyper flashing turn signal issue without disabling other vehicle features.

Various embodiments may achieve one or more advantages. For example, some embodiments may advantageously prevent the hyper-flash from occurring through the cyclic actuation of the relay in response to the pulsed output from the LCM. Various embodiments may advantageously protect the transistor from transient spikes and help control switching speed. Some embodiments may advantageously prevent accidental switching because the gate pull down resistor may ensure the MOSFET gate is held at 0 volts when no signal is present. Various embodiments may advantageously result in the voltage toggling to confirm proper turn-signal operation with the LCM 115. For example, this may advantageously prevent the hyper-flashing from occurring. Some embodiments may advantageously lower thermal stress and provide better heat spreading. Various embodiments may advantageously improve energy efficiency and reduce heat generation. This may, for example, advantageously prevent the electronics of the system from failure from significant heat exposure. Some embodiments mya advantageously disable the resistor array network, advantageously leading to improved energy efficiency and reduce heat generation.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary lighting control module system employed in an illustrative use-case scenario.

FIG. 2 depicts an exemplary turn signal module (TSM) employed in an illustrative use-case scenario.

FIG. 3 depicts an illustrative electrical schematic of an embodiment of a TSM.

FIG. 4 depicts an illustrative embodiment of a TSM.

FIG. 5 depicts an illustrative embodiment of a TSM.

FIG. 6 depicts an illustrative embodiment of a TSM.

FIG. 7 depicts an illustrative electrical schematic of an embodiment of a TSM.

FIG. 8 depicts an illustrative embodiment of a TSM.

FIG. 9 depicts an illustrative embodiment of a TSM.

FIG. 10 depicts an illustrative embodiment of a TSM.

FIG. 11 depicts an illustrative vehicle wire diagram.

FIG. 12 depicts an illustrative electrical schematic of an embodiment of a resistor array based electronic circuit (RABEC).

FIG. 13 depicts an illustrative graph depicting an illustrative relationship between a turn signal operation and resistor array activation.

FIG. 14 depicts an illustrative graph depicting an illustrative relationship between a turn signal operation and resistor array activation.

FIG. 15 depicts an illustrative graph depicting an illustrative relationship between a turn signal operation and resistor array activation.

FIG. 16 depicts a printed circuit board coupled to a wire harness.

FIG. 17 depicts an illustrative method of using the RABEC.

FIG. 18 depict an illustrative thermal image of an exemplary resistor array board.

Like reference symbols in the various drawings indicate like elements.

### DETAILED DESCRIPTION OF ILLUSTRATIVE EMBODIMENTS

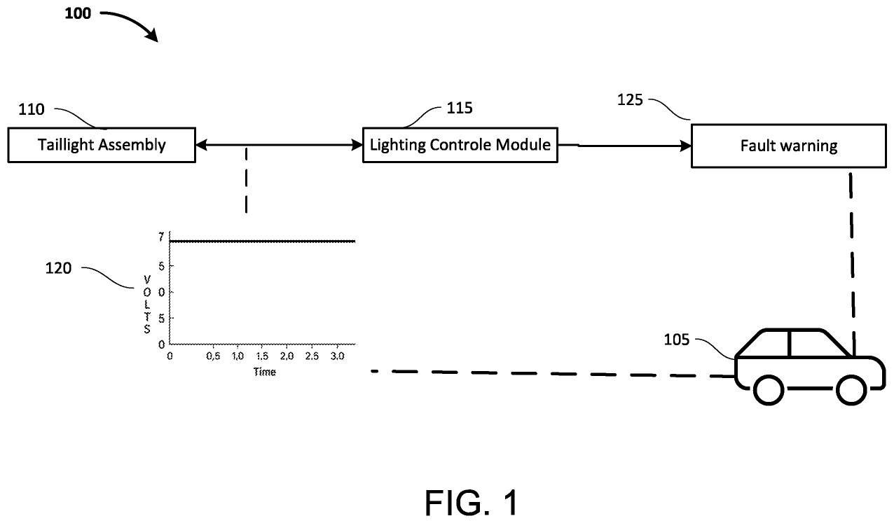

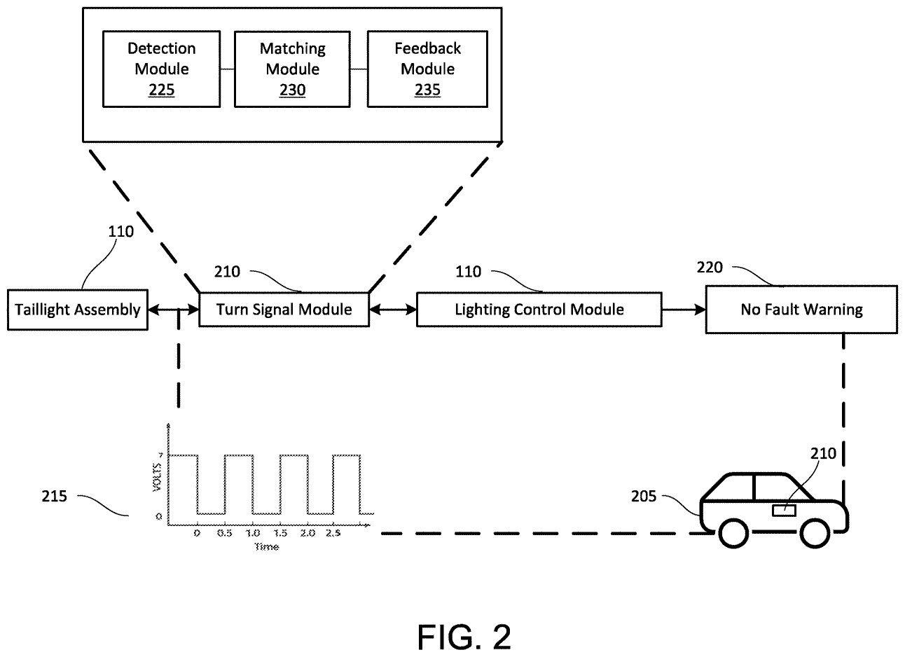

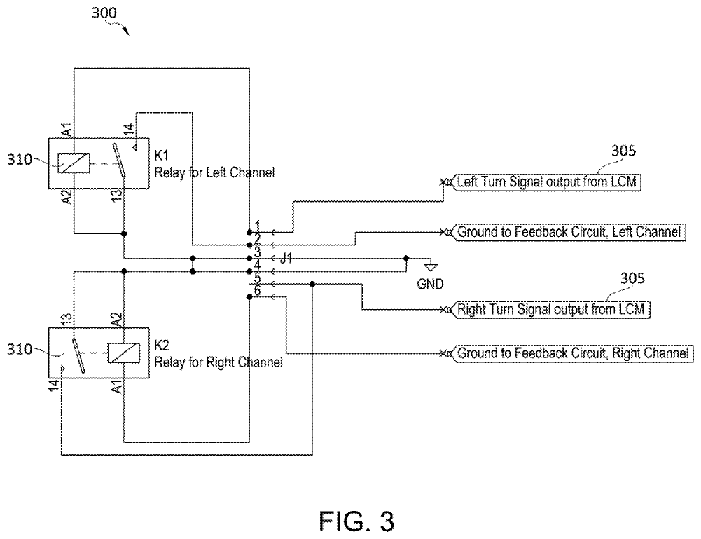

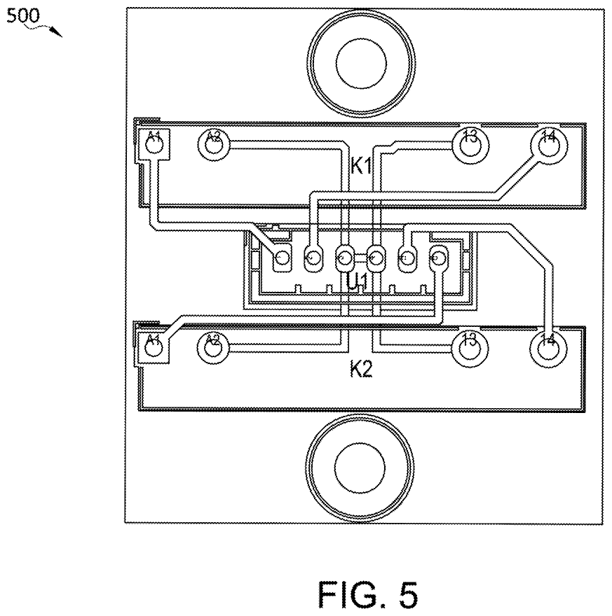

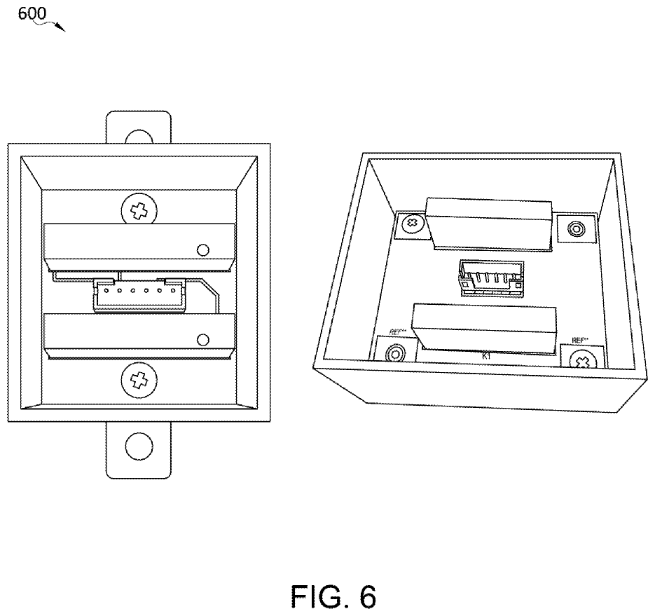

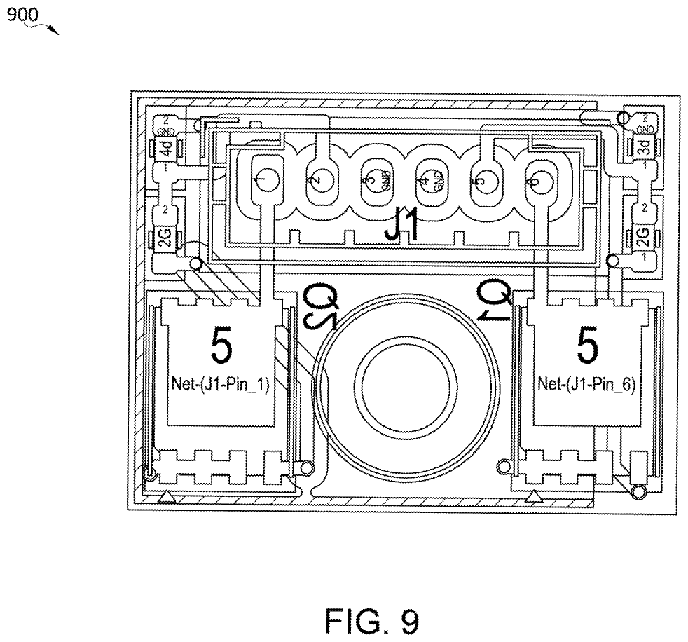

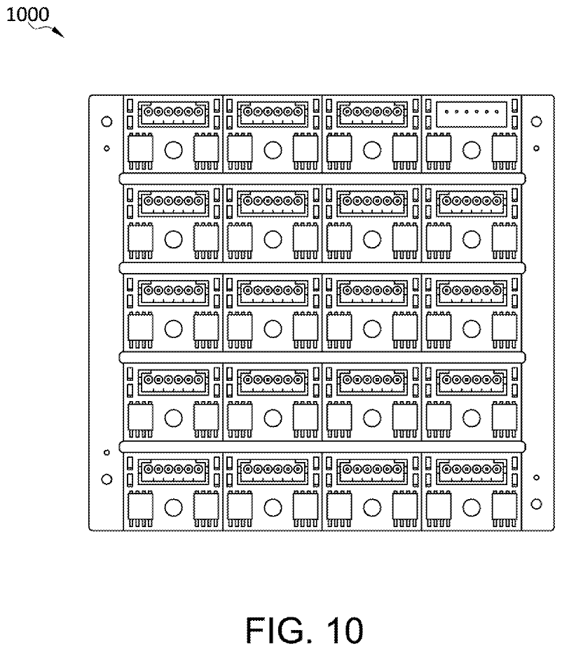

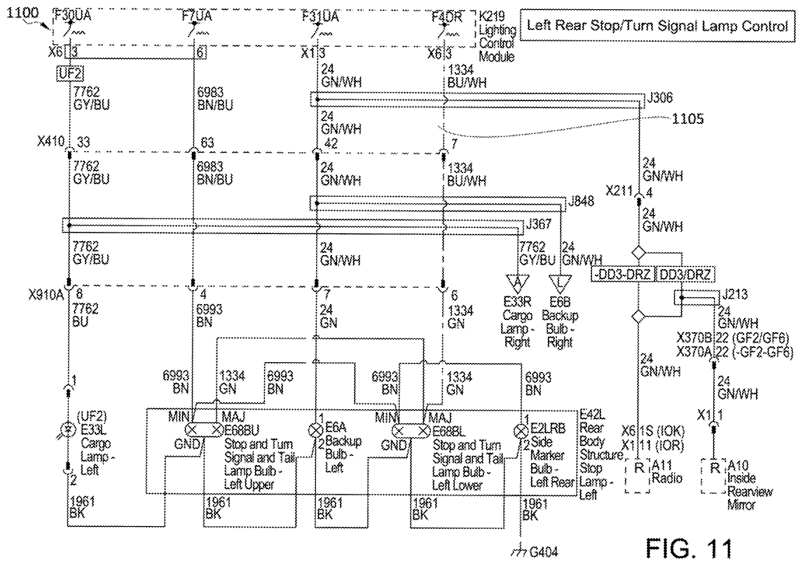

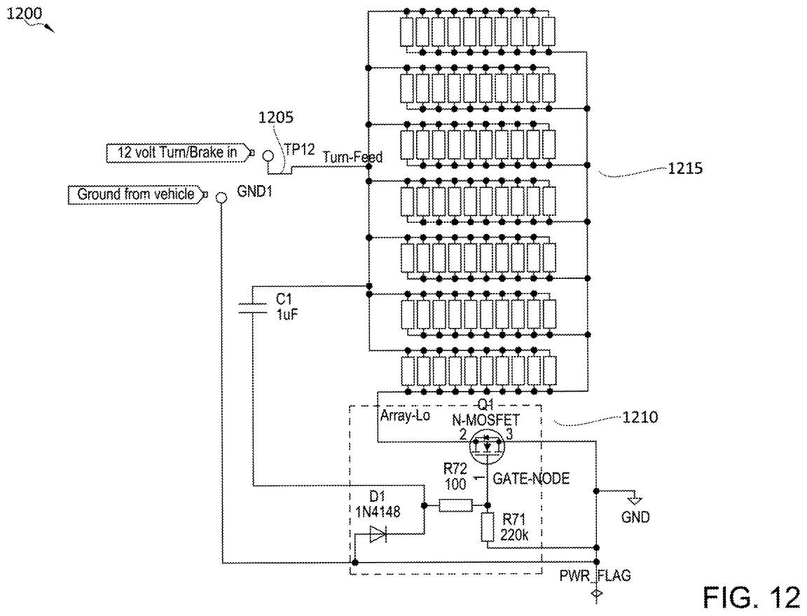

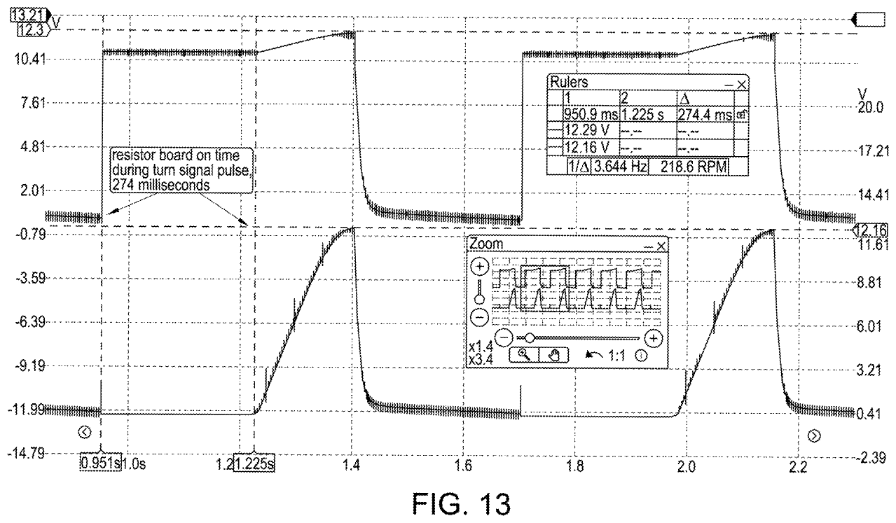

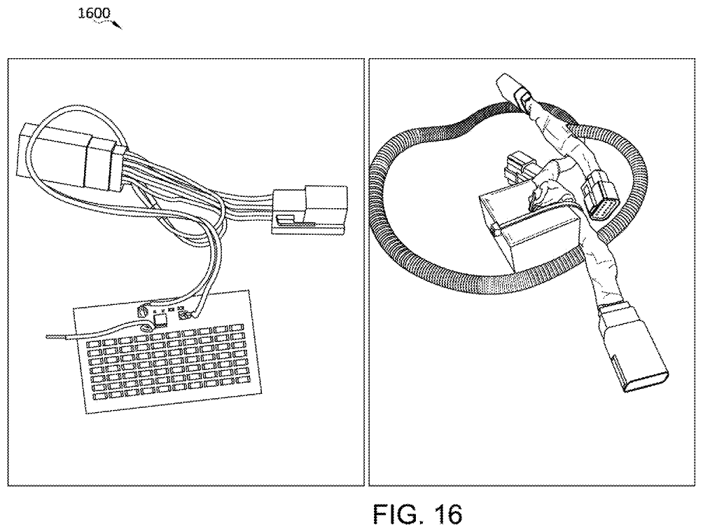

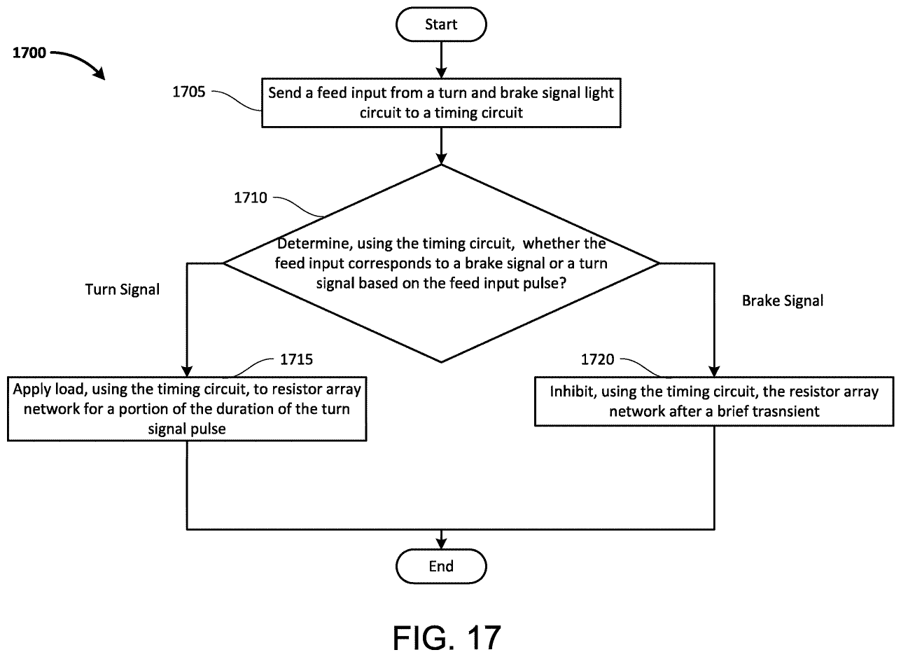

To aid understanding, this document is organized as follows. First, to help introduce discussion of various embodiments, a turn signal module is introduced with reference to FIGS. 1-2*. Second, that introduction leads into a description with reference to FIGS. 3-10 of some exemplary embodiments of a turn signal module. Third, with reference to FIGS. 11-12, a resistor array based electronic circuit (RABEC) is described. Fourth, with reference to FIGS. 13-15, the discussion turns to exemplary embodiments that depict illustrative relationships between turn signal operations and resistor array activation. Fifth, and with reference to FIG. 16, this document describes exemplary apparatus for deploying the resistor array based electronic circuit. Sixth, this disclosure turns to an illustrative method of using the resistor array based electronic circuit in FIG. 17. Seventh, this disclosure discusses a thermal image of an exemplary resistor array board utilized that may be utilized in the RABEC.

FIG. 1 depicts an exemplary turn signal module (TSM) employed in an illustrative use-case scenario. An illustrative scenario 100 is depicted in FIG. 1. A vehicle 105 is equipped with a taillight assembly 110. In some examples, the taillight assembly 110 may be a modified taillight assembly installed in the vehicle after the original taillights are removed. In some embodiments, the taillight assembly includes LED lights. Some trucks may, for example, modify the taillight assembly 110 by removing the entire truck bed and then outfitting a utility truck bed to the truck. The vehicle 105 has a lighting control module (LCM 115). In some examples, The LCM 115 sends a signal to the taillight assembly 110. In various examples, the signal sent by the LCM may be voltage on a feedback circuit to the taillight assembly.

In some instances, when a factory taillight assembly is installed, the LCM 115 sends voltage on a feedback circuit to the factory taillight assembly. When the turn signal is activated by the driver, the illumination of the turn signal causes the feedback circuit to be grounded and drops the voltage to 0 volts. When the turn signal light is off, the voltage returns on the feedback circuit.

In some examples, the taillight assembly 110 may not be configured to interact with the LCM 115. In some examples, the taillight assembly 110 may not ground the voltage or return the voltage on a feedback circuit. In these scenarios, the voltage sent to and from the LCM 115 remains static, resulting in voltage graph 120. The taillight assembly 110 may, for example, not be configured to send the feedback signal back to the LCM 115. The static voltage, as shown in the voltage graph 120, may, in some examples, result in a fault warning 125 being generated by the LCM 115. The fault warning 125 may, for example, be sent to a display system of the vehicle 105 to indicate an issue. The fault warning 125 may, in some examples, result in hyper flashing of the taillight assembly when the turn signal is activated by the user.

FIG. 2 depicts an illustrative electrical schematic of an embodiment of a TSM. An illustrative scenario 200 is depicted in FIG. 2. A vehicle 205 is equipped with a modified taillight assembly 110 and a turn signal module (TSM 210). The taillight assembly 110 and the TSM 210 may, for example, be installed at the vehicle's 205 wire harness. The TSM 210 may, for example, be configured to mimic the feedback signal back to the LCM 115. In various examples, the mimicking may mimic the expected feedback waveform detected by the LCM 115. In some examples, the TSM 210 may operate via a relay-based design. In various examples, the TSM 210 may operate via a MOSFET-based transistor circuit design. The operation of the TSM 210 may, in some examples, be configured to mimic the behavior of the factory taillight assembly. In these scenarios, the voltage sent to and from the LCM 115 oscillates between 0 volts and X volts, as shown by voltage graph 215. In some examples, X volts may be 7 volts. The voltage graph 215 may, in some implementations, be step-wise. The step-wise voltage may, for example, result in no fault warning being generated in the vehicle 220.

In some examples, the TSM 210 may be configured to mimic a functioning LED light by interacting with the vehicle's feedback circuit and sending a signal to the LCM 115. This may, for example, advantageously prevent the LCM 115 from detecting a fault, preventing the hyper flashing turn signal issue without disabling other vehicle features.

In various implementations, the TSM 210 may include a left-side module configured to receive a left turn signal control input and provide a corresponding left turn feedback signal indicative of activation of a left turn signal circuit. In some implementations, the TSM 210 may include a right-side module configured to receive a right turn signal control input and provide a corresponding right turn feedback signal indicative of activation of a right turn signal circuit. In some examples, this may advantageously prevent the LCM 115 from detecting a fault when either the left turn signal control input or the right turn signal control input are generated.

In various examples, the left-side module and the right-side module may be connected to a common ground connection. In some implementations, the left-side module may be connected to a left-side feedback ground connection and the right-side module may be connected to a right-side feedback ground connection. In various implementations, the left-side feedback ground connection and the right-side feedback ground connection may be configured to provide a reference for monitoring operational status of the respective turn signal lamp.

In some examples, a turn signal control system for a vehicle may include a first electrical module configured to receive a first turn signal control input and provide a corresponding first feedback signal indicative of activation of a first turn signal circuit; a second electrical module configured to receive a second turn signal control input and provide a corresponding second feedback signal indicative of activation of a second turn signal circuit; a common ground connection coupled to the first and second electrical modules; and a first feedback ground connection for the first electrical module and a second feedback ground connection to the second electrical module, each configured to provide a reference for monitoring operational status of the respective turn signal lamp.

In various examples, the turn signal control system for a vehicle may include a TSM 210 for resolving electrical issues in a vehicle including a detection module 225, a matching module 230, and a feedback module 235 being operably coupled; the detection module 225 being configured to detect a target signal; the matching module 240 being configured to match the target signal; the feedback module being configured to generate the target signal.

In various examples, the TSM may include operably coupled modules. These modules may, for example, be the detection module 225, the matching module 230, and the feedback module 235. The modules may, for example, resolve the hyper-flashing and/or fault warning generated by the LCM 115.

In some embodiments, the detection module 225 may be responsible for monitoring the turn signal control input generated by the LCM and identifying the presence of a target signal. In various examples, the LCM 115 outputs a pulsed turn signal control input during normal turn signal operation. The matching module 230 may, for example, operate downstream of detection and may be configured to translate or match the detected target signal into a form expected by the LCM's feedback monitoring circuitry. In some examples, the LCM 115 may expect a time-varying feedback waveform that alternates between a grounded state and non-grounded state during turn signal operation. In various implementations, the matching module 230 may ensure that the electrical behavior produced by the TSM 210 conforms to the signaling patterns recognized by the LCM 115. In various implementations, the feedback module 235 may actively generate the feedback signal returned to the LCM based on the matched signal produced by the matching module 230. In some examples, the feedback module 235 may produce an oscillating feedback signal that mimics the electrical behavior of a factory-installed turn signal lamp. For example, the generated feedback signal may confirm proper turn signal operation to the LCM. This may, for example, advantageously prevent fault warnings and hyper-flashing and also operates without disabling other vehicle lighting functions.

FIG. 3 depicts an illustrative electrical schematic of an embodiment of a TSM. A relay-based TSM design 300 is shown. In some examples, the relay-based TSM design 300 includes an input coupled to an LCM turn signal output 305. The LCM turn signal output 305 may, for example, provide a pulsed drive signal that is electrically coupled to a relay coil 310, such that transitions of the turn signal output correspondingly energize and de-energize the relay coil 310. In some examples, when the relay coil 310 is energized during an ON phase of the pulsed turn signal output, a magnetic field generated by the coil actuates the mechanical relay contacts. Actuation of the relay contacts may, for example, electrically couple a feedback node to a ground reference, thereby pulling the feedback circuit to a substantially zero-volt potential. This grounded state may, for example, correspond to a low-voltage portion of an expected feedback waveform. Conversely, during an OFF phase of the pulsed turn signal output, the relay coil 310 may, for example, no longer be energized, allowing the relay contacts to return to their normally open position. In this state, the feedback node may, in some examples, be electrically decoupled from ground, and the voltage on the feedback circuit returns to a higher reference level provided by the vehicle system. For example, in this state, the absence of the turn signal may allow the voltage on the feedback circuit to return to a higher reference level provided by the vehicle system.

In some examples, the cyclic actuation of the relay in response to the pulsed output from the LCM may cause the relay-based TSM design 300 to generate a time-varying feedback signal that alternates between a grounded state and a non-grounded state in synchrony with the turn signal control. The resulting feedback waveform includes repeating transitions between approximately 0 volts during the ON phase and a higher voltage level during the OFF phase. In some examples, the voltage level may be 7 volts. This switching behavior replicates the electrical characteristics associated with mechanical contact closure and release, thereby producing a feedback signal profile that conforms to signaling patterns recognized by the LCM 115 during normal turn signal operation In some examples, the cyclic actuation of the relay in response to the pulsed output from the LCM may advantageously prevent the hyper-flash from occurring.

In some examples, the LCM 115 outputs a pulsed voltage to flash the turn signal lamps for each side (left/right). In the relay-based TSM design 300, electromechanical relays may be used for left and right turn circuits. In various examples, the LCM 115 provides a pulsed turn-signal output.

In various examples, the turn control system for a vehicle may include a first electrical module configured to receive a first turn signal control input and provide a corresponding first feedback signal indicative of activation of a first turn signal circuit. In some examples, the turn control system may include, for example, a second electrical module configured to receive a second turn signal control input and provide a corresponding second feedback signal indicative of activation of a second turn signal circuit. The turn control system may, in some implementations, include a common ground connection coupled to the first and second electrical modules. The turn control system may, in some embodiments, include a first feedback ground connection for the first electrical module and a second feedback ground connection to the second electrical module, each configured to provide a reference for monitoring operational status of the respective turn signal lamp.

In various examples, the detection module in the relay-based TSM design 300 may be performed by energizing and de-energizing a relay coil in response to the pulsed LCM 115 output.

In some implementations, the LCM turn signal control input and the LCM turn signal output may be a pulsed drive signal from the LCM. For example, this may correspond to the signal that alternates between high and low to command flashing.

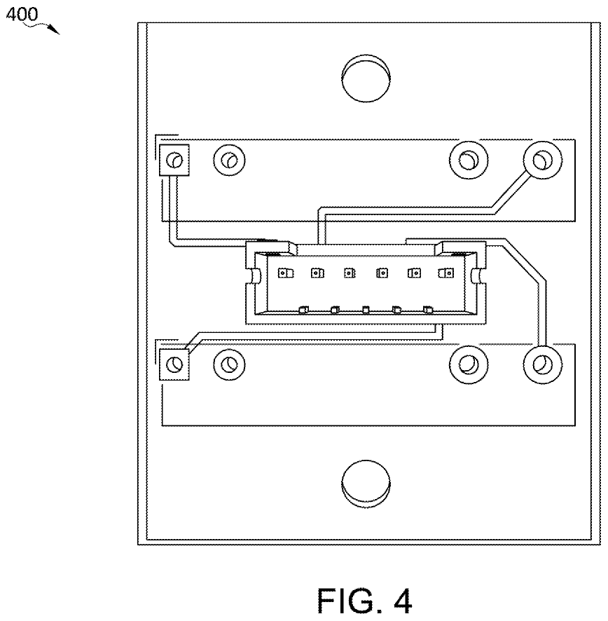

FIGS. 4-6 depict an illustrative embodiment of a TSM. As depicted in FIGS. 4-6, the circuit board of the relay-based TSM design 300 includes the logical wiring converted into a PCB.

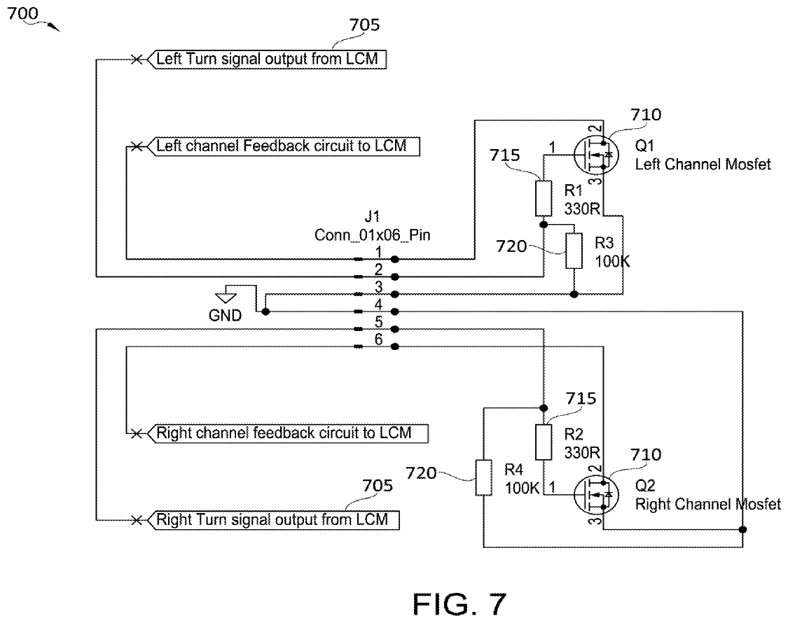

FIG. 7 depicts an illustrative electrical schematic of an embodiment of a TSM. A MOSFET-based TSM design (MD 700) is depicted in FIG. 7. The MD 700 may, for example, include a MOSFET LCM turn signal output 705. The MOSFET LCM turn signal output 705 may, for example, drive the MOSFET gate 710. When the LCM 115 generates the pulsed MOSFET LCM turn signal output 705, the same output is fed into the MOSFET gate 710. The MD 700 may, for example, include a gate resistor 715 and a gate pull down resistor 720 to ensure proper operation of the MOSFET gate 710. For example, the gate resistor 715 may advantageously protect the transistor from transient spikes and help control switching speed. In various examples, the gate pull down resistor 720 may ensure the MOSFET gate 710 is held at 0 volts when no signal is present, advantageously preventing accidental switching.

In some examples, when the turn signal is on, the MOSFET gate 710 voltage rises and energizes the MOSFET. This may, for example, mimic the flashing behavior of the original factory taillight. In some examples, when the MOSFET gate 710 turns on, the transistor provides a low-resistance path to ground between its source and drain terminals. In some examples, this pulls the feedback circuit to 0 volts. When the MOSFET turns off, the feedback circuit floats back up to 7 volts. This may, for example, advantageously result in the voltage toggling to confirm proper turn-signal operation with the LCM 115. For example, this may advantageously prevent the hyper-flashing from occurring. In various examples, the gate resistor 715 may be configured to hold the MOSFET gate 710 in a non-conductive state in the absence of the turn signal control input.

In various examples, the detection module 225 in the MD 700 may be performed by applying the pulsed LCM output to the MOSFET gate 710.

In various examples, the MD 700 provides a solid-state switching method with a compact surface-mount technology arrangement with minimal power draw.

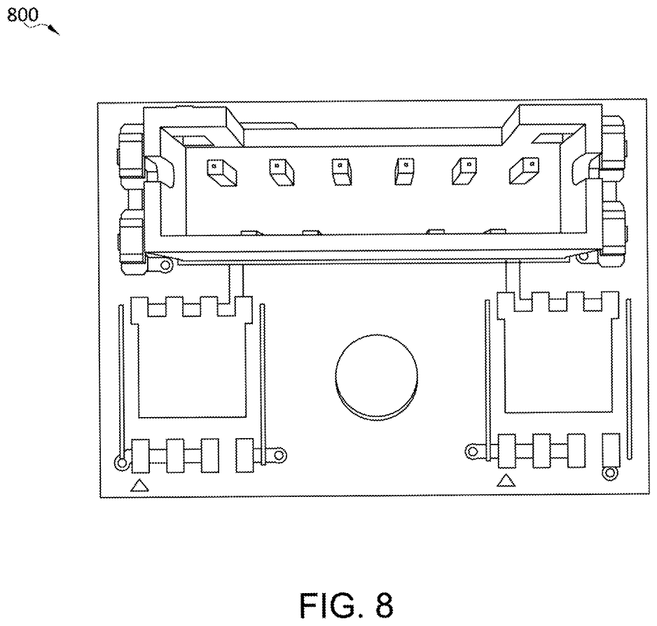

FIGS. 8-10 depict an illustrative embodiment of a TSM. As depicted in FIGS. 8-10, the circuit board of the MID 700 includes the logical wiring converted into a PCB pattern.

FIG. 11 depicts an illustrative vehicle wire diagram. In some vehicles, a turn and brake signal light circuit (TBSLC 1105) is configured to operate as both the turn signal and brake light circuit. In some arrangements, conventional resistors may be energized utilizing both turn signal functionality and brake light functionality.

FIG. 12 depicts an illustrative electrical schematic of an embodiment of a resistor array based electronic circuit (RABEC). A resistor array based electronic circuit (RABEC 1200) is depicted in FIG. 12. In some examples, a feed input 1205 comes from the TBSLC 1105. In various examples, the feed input may be 12 volts. The feed input 1205 may, for example, be the power source that the RABEC 1200 monitors to determine whether a turn signal pulse is occurring. The RABEC includes a timing circuit 1210 and a resistor array network 1215. The timing circuit 1210 includes several components that form a timing control network. The components may, for example, include a transistor/MOSFET switch, a timing capacitor, and/or resistors. In some examples, the timing circuit 1210 may be configured to detect when the turn signal is being operated. In various examples, the timing circuit 1210 may be configured to detect when the brake signal is being operated. For example, the timing circuit 1210 may be able to determine when the brake signal is being operated or the turn signal is being operated. This may, for example, advantageously prevent the resistors in the resistor array network 1215 from overheating.

In various examples, the resistor array network 1215 may include several individual resistors connected in parallel. In some examples, the resistor array network 1215 may include 2-300 resistors connected in parallel. In various examples, the resistor array network 1215 may include 70 resistors. In some examples, the use of several small resistors may share the load. This may, for example, lower thermal stress and provide better heat spreading. For example, the several small resistors provide the same effective working resistance while preventing the individual resistors from overheating.

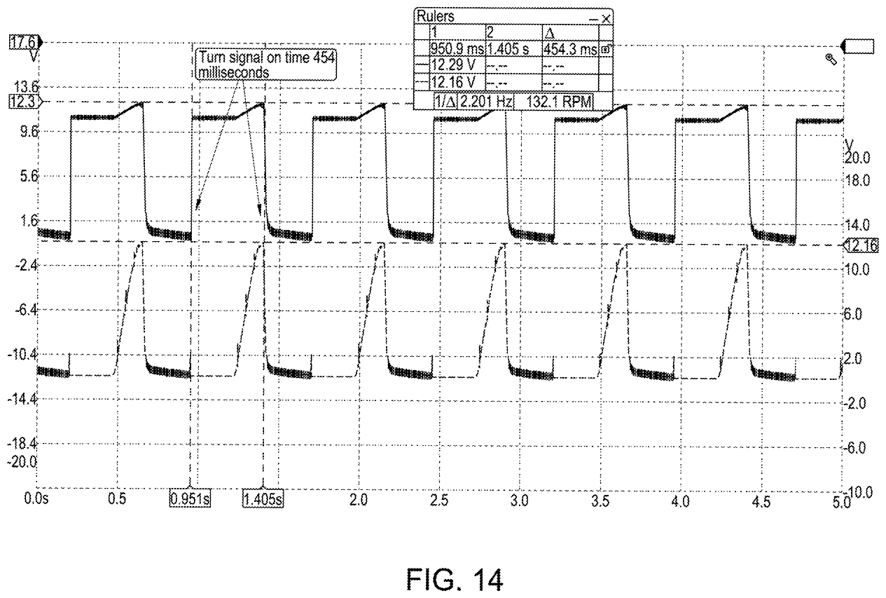

In some examples, the timing circuit 1210 may determine a turn signal by detecting the rising edge of a turn signal pulse, as depicted in FIGS. 13 and 14. This may, for example, activate the resistor array network 1215 for a period shorter in duration than the duration for the turn signal pulse. In some examples, the resistor array network 1215 is activated for about 274 microseconds and the turn signal pulse lasts about 451 microseconds. The resistor array network 1215 may, for example, automatically turn off after the timing window (e.g., about 274 microseconds) expires.

In some examples, the timing circuit 1210 detecting a turn signal applies a load to the resistor array only for a controlled time portion of the turn-signal pulse. This arrangement may, for example, advantageously improve energy efficiency and reduce heat generation. For example, the detection of the turn signal prevents energy from being wasted by keeping resistors on longer than required because the activation time is intentionally limited, thus resulting in lower total power used across repeated pulses. In some examples, the detection of the turn signals reduces heat generation by energizing the resistor array for significantly less time than the turn signal pulse. In various examples, this enables significant advantages as it prevents the electronics from failure from significant heat exposure.

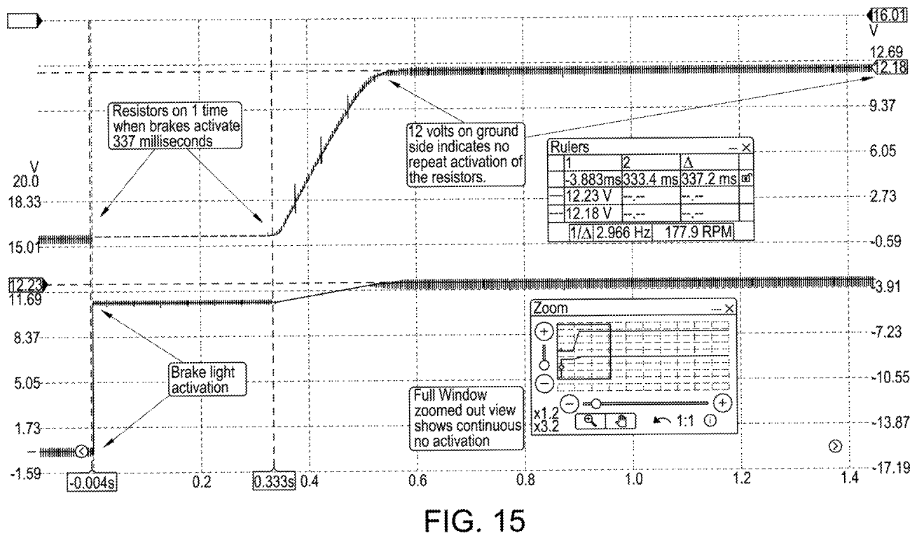

In various examples, the timing circuit 1210 may determine a brake signal by detecting a steady-state voltage with no pulsing, as depicted in FIG. 15. This detection may, for example, allow the timing circuit 1210 to inhibit the resistor array network 1215 activation after a brief transient. For example, this advantageously disables the resistor array network 1215 for the entire duration of the brake signal 1220. In some examples, the timing circuit 1210 stops current flowing through the load resistors during braking, thus preventing power from being wasted. This may, for example, advantageously lead to less heat generation from the resistors because they are not activated during a brake operation. For example, brake lights may stay on for several minutes at a time. During such operations, the resistors generate little to no additional heat.

In some examples, the timing circuit 1210 detects a pulsed turn signal and a steady brake signal that allows the system to manage the resistor array network.

In various embodiments, the RABEC 1200 may be arranged on a metal core printed circuit board. This may, for example, provide a thermally conductive substrate that spreads the reduced heat load across a larger mass. In some examples, the combination of distributed electrical loading and metal core heat spreading results in substantially lower operating temperature and reduces risk to surrounding nearby vehicle components.

In various examples, the RABEC 1200 may be integrated into the same electrical arrangement as the TSM 210. This may, for example, allowing both to interface seamlessly with vehicles.

FIG. 16 depicts a printed circuit board coupled to a wire harness. A wire harness 1600 serves as the physical interface between the vehicle's factory rear-lighting connector and the relay-based design 300, the MD 700, and/or the RABEC 1200. The wire harness 1600 may, in some examples, couple the relay-based design 300 and the RABEC 1200 with the LCM 115. In various examples, the wire harness 1600 may couple the MD 700 and the RABEC 1200 with the LCM 115. The wire harness 1600 may, for example, create a plug and play connection between the relay-based design 300, the MD 700, and/or the RABEC 1200. This may, for example, advantageously prevent the need for cutting of factory wiring. In some examples, the vehicle's male connector may be the connector that normally plugs into the tail lamp. Once connected, the relay-based design 300, the MID 700, and/or the RABEC 1200 operably coupled to the wire harness 1600 may be configured to interpret the signals it receives from the vehicle.

In some examples, the vehicle may have a factory male connector that operably couples to the female connector of the wire harness. In some examples, the wire harness 1600 may be operably coupled to the relay-based design 300 and the RABEC 1200. In various examples, the wire harness 1600 may be operably coupled to the MD 700 and the RABEC 1200. In some examples, the relay-based design 300 and the RABEC 1200 are coupled to a wire harness output. In some embodiments, the MD 700 and the RABEC 1200 are coupled to a wire harness output. The wire harness output may, for example, be a male connector. The wire harness output may, in some examples, be operably coupled to the aftermarket tail lamp. In some examples, the wire harness 1600 may use MOLEX connectors to operably couple to the vehicle and the aftermarket tail lamp.

FIG. 17 depicts an illustrative method of an illustrative RABEC. Method 1700 starts with sending a feed input from a turn and brake signal light circuit to a timing circuit in step 1705. A decision point is reached in step 1710, where a determination, using the timing circuit, whether the feed input corresponds to a brake signal or a turn signal based on the feed input pulse is made. If it is determined the feed input corresponds to a turn signal, then a load, using the timing circuit, must be applied to a resistor array network for a portion of the duration of the turn signal pulse in step 1715. If it is determined the feed input corresponds to a turn signal, then the timing circuit will inhibit the resistor array network after a brief transient in step 1720.

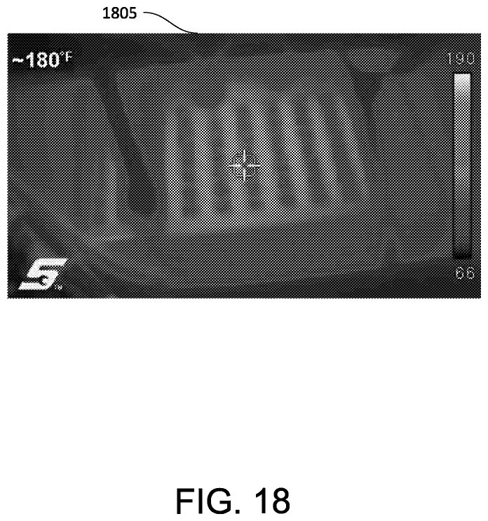

FIG. 18 depict illustrative thermal images of the RABEC. As depicted by FIG. 18, a resistor array board 1805 exhibits an advantageously low and spatially uniform temperature profile after approximately twenty minutes of repeated activation, indicating that the heat generation across the resistor array board is substantially limited and distributed across the resistor array board structure. This resistor array board 1805 may, for example, be utilized in the RABEC 1200.

In some examples, the thermal behavior results from powering the resistor array board 1805 only for controlled durations during turn signal events and from distributing the electrical load across several resistor array elements. By limiting continuous current flow and spreading thermal energy over a larger surface area, the resistor array board 1805 configuration advantageously reduces peak operating temperatures and mitigates localized heat accumulation. In some examples, the resistor array board 1805 configuration reduces the max temperature by 380 degrees Fahrenheit. This may, for example, advantageously prolong the life of the resistor array board 1805 and its individual components.

Although various embodiments have been described with reference to the figures, other embodiments are possible.

Although an exemplary system has been described with reference to FIGS. 1-18, other implementations may be deployed in other industrial, scientific, medical, commercial, and/or residential applications.

In various embodiments, a vehicle lighting control system may include both a TSM and a RABEC incorporated within the same system or assembly. In such embodiments, the TSM may be configured to interact with a vehicle lighting control module (LCM) to generate a feedback signal that mimics operation of a factory-installed turn signal lamp by selectively coupling and decoupling a feedback circuit to ground in synchrony with a pulsed turn signal input, thereby preventing fault detection or hyper-flashing conditions. The RABEC may be electrically coupled to a turn and brake signal light circuit and may include a timing circuit configured to distinguish a pulsed turn signal from a steady brake signal based on temporal characteristics of a feed input. In response to detecting a turn signal, the timing circuit may selectively activate a resistor array network for a limited portion of a turn signal pulse to simulate proper electrical loading while reducing power dissipation, and in response to detecting a brake signal, may inhibit activation of the resistor array network after a transient period to prevent excessive heat generation. In some implementations, the TSM and the RABEC may be integrated on a common printed circuit board or coupled via a wire harness configured for plug-and-play installation with a factory vehicle connector, allowing the combined system to cooperatively provide feedback signal simulation and controlled resistive loading without disabling other vehicle lighting functions or requiring modification of factory wiring.

In various implementation, the detection module 225 may sense the pulsed input and determine whether the turn signal is in an ON phase or an OFF phase In some implementations, the relay contact or MOSFET switching path may be selectively enable or disable in synchrony with the detected turn signal via the matching module 230. This matching behavior may, for example, advantageously align the feedback circuit response with the expected factory lamp behavior, including oscillation between approximately 0 volts during ON phases and a higher reference voltage (e.g., 7 volts) during OFF phases.

In some examples, the feedback circuit may be a vehicle electrical line monitored by the LCM to confirm proper turn signal lamp operation by detecting an expected, time-varying voltage waveform on that line. In various examples, such as in a factory configuration, the LCM may provide a voltage on the feedback circuit, and when the turn signal lamp is in an ON state, the feedback circuit may be selectively pulled to a reference potential (e.g., ground) such that the feedback voltage drops to approximately 0 volts. In various implementations, when the lamp is OFF, the feedback circuit may not be pulled to ground and the voltage returns to a higher level (e.g., about 7 volts), thereby producing an oscillating waveform that the LCM interprets as normal operation. In some examples, a feedback ground connection may be a reference and/or return node associated with the feedback circuit for either the left side or the right side that may be selectively coupled to a common ground connection to create the grounded portion of the expected feedback waveform. The feedback ground connection may, in some examples, be selectively decoupled during OFF phases so the feedback circuit returns high, enabling the LCM to monitor operational status without relying solely on the lamp load.

In various examples, the common ground may be a general return mode that the modules share as the 0 volt reference.

In various embodiments, some bypass circuits implementations may be controlled in response to signals from analog or digital components, which may be discrete, integrated, or a combination of each. Some embodiments may include programmed, programmable devices, or some combination thereof (e.g., PLAs, PLDs, ASICs, microcontroller, microprocessor), and may include one or more data stores (e.g., cell, register, block, page) that provide single or multi-level digital data storage capability, and which may be volatile, non-volatile, or some combination thereof. Some control functions may be implemented in hardware, software, firmware, or a combination of any of them.

Computer program products may contain a set of instructions that, when executed by a processor device, cause the processor to perform prescribed functions. These functions may be performed in conjunction with controlled devices in operable communication with the processor. Computer program products, which may include software, may be stored in a data store tangibly embedded on a storage medium, such as an electronic, magnetic, or rotating storage device, and may be fixed or removable (e.g., hard disk, floppy disk, thumb drive, CD, DVD).

Although an example of a system, which may be portable, has been described with reference to the above figures, other implementations may be deployed in other processing applications, such as desktop and networked environments.

Temporary auxiliary energy inputs may be received, for example, from chargeable or single use batteries, which may enable use in portable or remote applications. Some embodiments may operate with other DC voltage sources, such as a 9V (nominal) batteries, for example. Alternating current (AC) inputs, which may be provided, for example from a 50/60 Hz power port, or from a portable electric generator, may be received via a rectifier and appropriate scaling. Provision for AC (e.g., sine wave, square wave, triangular wave) inputs may include a line frequency transformer to provide voltage step-up, voltage step-down, and/or isolation.

Although particular features of an architecture have been described, other features may be incorporated to improve performance. For example, caching (e.g., L1, L2, . . . ) techniques may be used. Random access memory may be included, for example, to provide scratch pad memory and or to load executable code or parameter information stored for use during runtime operations. Other hardware and software may be provided to perform operations, such as network or other communications using one or more protocols, wireless (e.g., infrared) communications, stored operational energy and power supplies (e.g., batteries), switching and/or linear power supply circuits, software maintenance (e.g., self-test, upgrades), and the like. One or more communication interfaces may be provided in support of data storage and related operations.

Some systems may be implemented as a computer system that can be used with various implementations. For example, various implementations may include digital circuitry, analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Various embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and CD-ROM and DVD-ROM disks. The processor and the memory can be supplemented by, or incorporated in, ASICs (application-specific integrated circuits).

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. Various embodiments may be implemented in a computer system that includes a graphical user interface and/or an Internet browser. To provide for interaction with a user, some implementations may be implemented on a computer having a display device. The display device may, for example, include an LED (light-emitting diode) display. In some implementations, a display device may, for example, include a CRT (cathode ray tube). In some implementations, a display device may include, for example, an LCD (liquid crystal display). A display device (e.g., monitor) may, for example, be used for displaying information to the user. Some implementations may, for example, include a keyboard and/or pointing device (e.g., mouse, trackpad, trackball, joystick), such as by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, the computers and networks forming the Internet, or some combination thereof. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, multiplexing techniques based on frequency, time, or code division, or some combination thereof. Some implementations may optionally incorporate features such as error checking and correction (ECC) for data integrity, or security measures, such as encryption (e.g., WEP) and password protection.

In various embodiments, the computer system may include Internet of Things (IOT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

Various examples of modules may be implemented using circuitry, including various electronic hardware. By way of example and not limitation, the hardware may include transistors, resistors, capacitors, switches, integrated circuits, other modules, or some combination thereof. In various examples, the modules may include analog logic, digital logic, discrete components, traces and/or memory circuits fabricated on a silicon substrate including various integrated circuits (e.g., FPGAs, ASICs), or some combination thereof. In some embodiments, the module(s) may involve execution of preprogrammed instructions, software executed by a processor, or some combination thereof. For example, various modules may involve both hardware and software.

Clause 1. A turn signal control system including a first module connected to a common ground connection; a second module connected to the common ground connection; a first feedback ground connection for the first module; a second feedback ground connection for the second module; the first module being configured to receive a first turn signal control input from a vehicle lighting control module (LCM) and to mimic a first feedback signal indicative of activation of a first turn signal circuit; the second module being configured to receive a second turn signal control input from a vehicle LCM and to mimic a second feedback signal indicative of activation of a second turn signal circuit; and, the first feedback ground connection and the second feedback ground connection being configured to provide a reference for monitoring operational status of a corresponding turn signal lamp; wherein at least one of the first module and the second module is configured to selectively couple the corresponding feedback ground connection to the common ground connection in response to a pulsed turn signal control input in an ON phase and decouple the corresponding feedback ground connection from the common ground connection in response to an absence of the turn signal control input in a OFF phase.

Clause 2. The turn signal control system wherein at least one of the first module and the second module comprises a relay configured to cyclically ground the corresponding feedback ground connection in synchrony with the pulsed turn signal control input.

Clause 3. The turn signal control system wherein at least one of the first module and the second module comprises a solid-state switching device including a MOSFET having a gate coupled to the turn signal control input.

Clause 4. The turn signal control system further comprising a gate resistor configured to hold the MOSFET in a non-conductive state in the absence of the turn signal control input.

Clause 5. The turn signal control system wherein an oscillating feedback signal generated by the coupling and decoupling of the corresponding feedback ground connection prevents hyper-flashing of a turn signal indicator without disabling other vehicle lighting functions.

Clause 6. The turn signal control system further comprising a wire harness configured to electrically couple the first module and the second module to a factory vehicle connector.

Clause 7. The turn signal control system wherein, during the ON phase, a feedback waveform voltage is 0 volts.

Clause 8. The turn signal control system wherein, during the OFF phase, a feedback waveform voltage is 7 volts.

Clause 9. A turn signal control system including a first module connected to a common ground connection; a second module connected to the common ground connection; a first feedback ground connection for the first module; a second feedback ground connection for the second module; the first module being configured to receive a first turn signal control input from a vehicle lighting control module (LCM) and to mimic a first feedback signal indicative of activation of a first turn signal circuit; and, the second module being configured to receive a second turn signal control input from a vehicle LCM and to mimic a second feedback signal indicative of activation of a second turn signal circuit.

Clause 10. The turn signal control system wherein the first feedback ground connection and the second feedback ground connection are configured to provide a reference for monitoring operational status of a corresponding turn signal lamp.

Clause 11. The turn signal control system wherein at least one of the first module and the second module is configured to selectively couple to the corresponding feedback ground connection to the common ground connection in response to a pulsed turn signal control input during an ON phase and decouple the corresponding feedback ground connection form the common ground connection in response to an absence of the turn signal control input during an OFF phase.

Clause 12. The turn signal control system wherein at least one of the first module and the second module comprises a relay.

Clause 13. The turn signal control system wherein at least one of the first module and the second module comprises a solid-state switching device including a MOSFET having a gate coupled to the turn signal control input.

Clause 14. The turn signal control system wherein an oscillating feedback signal generated by the coupling and decoupling of the corresponding feedback ground connection prevents hyper-flashing of a turn signal indicator without disabling other vehicle lighting functions.

Clause 15. The turn signal control system further comprising a wire harness configured to electrically couple the first module and the second module to a factory vehicle connector.

Clause 16. The turn signal control system wherein, during the ON phase, a feedback waveform voltage is 0 volts.

Clause 17. The turn signal control system wherein, during the OFF phase, a feedback waveform voltage is 7 volts.

Clause 18. A turn signal control system including a resistor array based electronic circuit (RABEC) electrically coupled to a turn and brake signal light circuit; the RABEC comprising: a timing circuit configured to monitor a feed input from the turn and brake signal light circuit to determine a turn signal or a brake signal based on temporal characteristics of the feed input; and, a resistor array network selectively coupled to the turn and brake signal light circuit under control of the timing circuit; wherein, in response to detecting a rising edge of a turn signal, activate the resistor array network for a limited portion of a duration of a turn signal pulse; and, wherein, in response to detecting the brake signal, inhibit activation of the resistor array network after a transient period.

Clause 19. The turn signal control system wherein the timing circuit activates the resistor array network for a duration shorter than the duration of the turn signal pulse

Clause 20. The turn signal control system wherein the resistor array network comprises a plurality of resistors connected in parallel to distribute thermal load.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A turn signal control system comprising:
a first module connected to a common ground connection;
a second module connected to the common ground connection;
a first feedback ground connection for the first module;
a second feedback ground connection for the second module;
the first module being configured to receive a first turn signal control input from a vehicle lighting control module (LCM) and to mimic a first feedback signal indicative of activation of a first turn signal circuit;
the second module being configured to receive a second turn signal control input from a vehicle LCM and to mimic a second feedback signal indicative of activation of a second turn signal circuit; and,
the first feedback ground connection and the second feedback ground connection being configured to provide a reference for monitoring operational status of a corresponding turn signal lamp;
wherein at least one of the first module and the second module is configured to selectively couple the corresponding feedback ground connection to the common ground connection in response to a pulsed turn signal control input in an ON phase and decouple the corresponding feedback ground connection from the common ground connection in response to an absence of the turn signal control input in a OFF phase.

2. The turn signal control system of claim 1, wherein at least one of the first module and the second module comprises a relay configured to cyclically ground the corresponding feedback ground connection in synchrony with the pulsed turn signal control input.

3. The turn signal control system of claim 1, wherein at least one of the first module and the second module comprises a solid-state switching device including a MOSFET having a gate coupled to the turn signal control input.

4. The turn signal control system of claim 3, further comprising a gate resistor configured to hold the MOSFET in a non-conductive state in the absence of the turn signal control input.

5. The turn signal control system of claim 1, wherein an oscillating feedback signal generated by the coupling and decoupling of the corresponding feedback ground connection prevents hyper-flashing of a turn signal indicator without disabling other vehicle lighting functions.

6. The turn signal control system of claim 1, further comprising a wire harness configured to electrically couple the first module and the second module to a factory vehicle connector.

7. The turn signal control system of claim 1, wherein, during the ON phase, a feedback waveform voltage is 0 volts.

8. The turn signal control system of claim 1, wherein, during the OFF phase, a feedback waveform voltage is 7 volts.

9. A turn signal control system comprising:
a first module connected to a common ground connection;
a second module connected to the common ground connection;
a first feedback ground connection for the first module;
a second feedback ground connection for the second module;
the first module being configured to receive a first turn signal control input from a vehicle lighting control module (LCM) and to mimic a first feedback signal indicative of activation of a first turn signal circuit; and,
the second module being configured to receive a second turn signal control input from a vehicle LCM and to mimic a second feedback signal indicative of activation of a second turn signal circuit.

10. The turn signal control system of claim 9, wherein the first feedback ground connection and the second feedback ground connection are configured to provide a reference for monitoring operational status of a corresponding turn signal lamp.

11. The turn signal control system of claim 10, wherein at least one of the first module and the second module is configured to selectively couple to the corresponding feedback ground connection to the common ground connection in response to a pulsed turn signal control input during an ON phase and decouple the corresponding feedback ground connection form the common ground connection in response to an absence of the turn signal control input during an OFF phase.

12. The turn signal control system of claim 9, wherein at least one of the first module and the second module comprises a relay.

13. The turn signal control system of claim 9, wherein at least one of the first module and the second module comprises a solid-state switching device including a MOSFET having a gate coupled to the turn signal control input.

14. The turn signal control system of claim 11, wherein an oscillating feedback signal generated by the coupling and decoupling of the corresponding feedback ground connection prevents hyper-flashing of a turn signal indicator without disabling other vehicle lighting functions.

15. The turn signal control system of claim 9, further comprising a wire harness configured to electrically couple the first module and the second module to a factory vehicle connector.

16. The turn signal control system of claim 11, wherein, during the ON phase, a feedback waveform voltage is 0 volts.

17. The turn signal control system of claim 11, wherein, during the OFF phase, a feedback waveform voltage is 7 volts.

18. A turn signal control system comprising:
a resistor array based electronic circuit (RABEC) electrically coupled to a turn and brake signal light circuit;
the RABEC comprising:
a timing circuit configured to monitor a feed input from the turn and brake signal light circuit to determine a turn signal or a brake signal based on temporal characteristics of the feed input; and,
a resistor array network selectively coupled to the turn and brake signal light circuit under control of the timing circuit;
wherein, in response to detecting a rising edge of a turn signal, activate the resistor array network for a limited portion of a duration of a turn signal pulse; and,
wherein, in response to detecting the brake signal, inhibit activation of the resistor array network after a transient period.

19. The turn signal control system of claim 18, wherein the timing circuit activates the resistor array network for a duration shorter than the duration of the turn signal pulse

20. The turn signal control system of claim 19, wherein the resistor array network comprises a plurality of resistors connected in parallel to distribute thermal load.
